(19) United States
(12) Patent Application Publication
(10) Pub. No.: US 2007/0054067 A1
(43) Pub. Date: Mar. 8, 2007

(54) Security document with upconverting material

(75) Inventor: Gary Fairless Power, Greenvale, VIC (AU)

Correspondence Address: BARNES & THORNBURG LLP, 750-17TH STREET NW, SUITE 900, WASHINGTON, DC, 20006-4675, US

(73) Assignee: SECURENCY PTY LIMITED, Craigieburn VIC (AU)

(21) Appl. No.: 10/575,634

(22) PCT Filed: Oct. 7, 2004
(86) PCT No.: PCT/AU04/01365

§ 371 Date: Jun. 30, 2006

(30) Foreign Application Priority Data
Oct. 9, 2003 (AU) 2003905517

(51) Int. Cl. G06K 19/06; B41M 5/00

(52) U.S. Cl. 428/32.22; 235/491

(57) ABSTRACT

A security document (1) comprises a substrate (10) including at least one layer of. polymeric material (12, 26) and containing an upconverting fluorescent material (18), and at least one coating (14) containing a refractive pigment applied to the substrate (10). When the security document is exposed to electromagnetic radiation of a particular wavelength, e.g. infra-red, the upconverting material (18) emits a signal of electromagnetic radiation of a shorter wavelength, e.g. visible light, and the coating (14) containing the refractive pigment enhances the signal.

This invention relates to security documents and is particularly concerned with providing a security document with a covert security device which is detectable in order to verify the authenticity of the security document.

As used herein, the term “security document” refers to any type of document or token for which authenticity is important, and includes within its scope documents and tokens of value, such as banknotes, cheques, travellers cheques, stock and share certificates, and tickets, and also identity documents and tokens, such as credit cards, identification cards, passports and the like.

The use of covert security devices for verification of security documents is well known. One example of a covert security device is a fluorescent ink applied to the surface of a security document and which emits light or luminesces when exposed to electromagnetic radiation of a particular wavelength, eg. Ultra-violet (UV) light.

The use of “upconverting” materials as covert security devices in security documents has also been proposed. An “upconverting” material is a material which absorbs electromagnetic radiation of a low energy level, eg. Infra-red, and emits electromagnetic radiation at higher energy level, such as visible light. This anti-stokes conversion of absorbed and emitted energy is caused by the upconverting material absorbing two photons of low energy and promoting a single electron to a higher energy state. When the electron returns to its original stable energy level, the material emits a photon of an energy level that is higher than the individual energy of the two incident photons.

Upconverting materials generally have an unusual structure, and examples of such materials include crystals or glasses doped with ions of rare earth metals, such as ytterbium (Yb) or thulium (Tm). The energy level of the emitted photons, and hence, the wavelength of the light emitted from such upconverting materials is uniquely characteristic of the particular upconverting material used. This makes upconverting materials of particular interest as covert security devices for the authentication of security documents.

Hitherto, there have been proposals to use inks containing upconverting materials as covert security devices in security documents. However, this has suffered from the disadvantage that the upconverting ink applied to the surface of a security document is exposed to adverse conditions during use of the security document. Banknotes, for example, are subjected to significant wear during their lifetime circulation. This can cause the signal emitted by the upconverting material to deteriorate over the lifetime of the security document. Also, upconverting materials applied to surface of a document are subject to chemical attack.

Further, upconverting materials are expensive to manufacture and so they are used only sparingly when added to security inks. However, it is necessary to use a sufficient amount of upconverting material in the ink in order to generate a signal which is sufficiently strong to be detected by appropriate apparatus. Thus a security ink containing an upconverting material is not usually applied over the whole surface of the security document. This has the disadvantage that the signal emitted from the upconverting material is only detectable over the particular region of the banknote where the upconverting ink has been applied.

It is therefore desirable to provide a security document containing an upconverting material in which at least some of the disadvantages of the prior art are alleviated.

It is also desirable to provide security document containing an upconverting material in which the signal strength of the signal from the upconverting material is enhanced.

According to one aspect of the invention, there is provided a security document comprising a substrate including at least one layer of polymeric material and containing an upconverting fluorescent material, and at least one coating containing a refractive pigment applied to the substrate, wherein when the security document is exposed to electromagnetic radiation of a particular wavelength the upconverting material emits a signal of electromagnetic radiation of a shorter wavelength and the coating containing the refractive pigment enhances the signal emitted by the upconverting material.

The substrate preferably includes a polymeric base layer. One example of such a base layer is a transparent biaxially oriented polymeric material of the type described in WO 83/00659. However, other types of base layers, for instance, of other polymeric materials, or even base layers of paper or fibrous materials, may be provided.

The substrate may also include one or more layers of polymeric material provided on the base layer. In this case, the upconverting material may be dispersed in either the base layer or in the at least one layer of polymeric material provided on the base layer.

Preferably, the coating containing the refractive pigment is in intimate contact with the at least one polymeric layer containing the upconverting material. This assists in amplifying the signal emitted by the upconverting material. This may be achieved by applying a refractive coating directly to at least one surface of a polymeric base layer containing the upconverting material. Alternatively, the refractive coating may be applied to the external surface of a layer of polymeric material containing the upconverting material which is provided on the base layer. It is, however, possible for the refractive coating to be applied to the surface of a layer of polymeric material provided on a base layer, with the base layer containing the upconverting material, though in this case the signal emitted from the security document may not be as strong.

The coating containing the refractive pigment is preferably a highly refractive opacifying coating. The opacifying coating may comprise at least one refractive pigment dispersed in a polymeric or resin binder. For example, the coating may include a major proportion of a refractive pigment bound with a minor proportion of a heat-activated cross-linkable polymeric binder.

Conveniently, the refractive pigments and binders are selected to be substantially transparent to the excitation wavelengths used to excite the upconverting material. The refractive pigments are preferably selected such that the difference between the refractive index of the pigment and the refractive index of the substrate is large. The difference between the refractive index of the pigment and the refractive index of the binder is preferably also large. In a particularly preferred embodiment, the refractive index of the pigment is at least 0.3 greater than the refractive index of either the substrate or the binder.

Examples of suitable refractive pigments include titanium dioxide (TiO₂), calcium carbonate (CaCO₃), barium sulphate (BaSO₄) and zinc oxide (ZnO). Examples of suitable binders include acrylics, polyester and polyurethane or similar polymers. The polymeric material may be cross-linked by cross-linking materials such as isocyanates, melamine condensates and similar materials. The proportion of the cross-linking material is preferably chosen so as to improve the resistance of the coating without impairing its function as a flexible, heat resistant, printable surface.

According to another aspect of the invention, there is provided a method of manufacturing a security document comprising: providing a substrate having at least one layer of polymeric material; incorporating at least one upconverting fluorescent material in the at least one layer of polymeric material; and applying a refractive coating to at least one surface of the substrate.

The upconverting material may be incorporated into the at least one layer of polymeric material in an extrusion process. This is particularly convenient for a security document which has a co-extruded base layer and/or at least one co-extruded polymeric layer provided on a base layer. The upconverting material is preferably present in small quantities in the polymeric material. In particular, for transparent substrates, the amount of upconverting material is preferably sufficiently small as to be substantially invisible in the transparent substrate. In one preferred embodiment, the concentration of upconverting material is not more than about 1% by weight of the polymeric material, and more preferably falls substantially within the range from about 0.0025% to about 0.25% by weight of the polymeric material.

In the extrusion process, the upconverting material is preferably mixed uniformly with the co-extruded polymeric material as it passes through the extruder and dies. This assists in producing a uniform distribution of the upconverting material throughout the at least one layer of polymeric material. Suitable apparatus for achieving this may include: scroll dies and barrier or twin screw extruders, eg. of the Werner Pflieder ZSK type. The upconverting material may be added to the polymeric material in the form of a master batch, for example through a loss-in-weight screw feeder.

Preferably, the upconverting material is mixed with the polymeric material, eg. in an extruder barrel, at an elevated temperature. For materials such as polypropylene, typical extrusion temperatures may fall substantially within the range from about 230° C. to 250° C.

Any convenient upconverting material or materials may be used in the present invention. Examples of suitable upconverting materials include crystals, glasses or metal oxide nanopowders doped with ions of Lanthanides, eg. Er³⁺, Tm³⁺, Nd³⁺, Ho³⁺ and Yb³⁺, although crystals doped with ions of some transition metals, eg. Ti²⁺, Ni³⁺, Mo³⁺, and Re⁴⁺ have also been found to exhibit upconverting properties. Examples of crystals which may be doped with such ions include halides, such as RbMnCl₃, CsMnCl₃, CsMnBr₃, and Rb₂MnCl₄, and tungstate crystals, such as NaY (WO₄)₂. Examples of suitable upconverting nanopowders include Al₂O₃ or yttrium aluminium garnet doped with Nd³⁺ or Ce³⁺.

In the case of a biaxially oriented polymeric substrate, the crystal structure of the upconverting material is preferably selected so as not to cause voids or air bubbles (intrusions) during the stretching process of biaxial orientation.

According to a further aspect of the invention, there is provided a method of verifying the authenticity of a security document comprising:

providing a substrate including at least one polymeric layer containing an upconverting fluorescent material;

providing the substrate with at least one opacifying coating containing a refractive pigment;

exposing the upconverting material to electromagnetic radiation of a selected wavelength to excite the upconverting material; and

detecting a signal of electromagnetic radiation emitted from the excited upconverting material at a shorter wavelength than the wavelength selected to excite the upconverting material.

In one preferred embodiment, the electromagnetic radiation selected to excite the upconverting material is infra-red radiation, and the signal of electromagnetic radiation emitted from the upconverting material falls within the visible spectrum. In this case an infra-red laser may be used to excite the upconverting material at the selected wavelength. It is, however, possible to use an upconverting material which is excited by electromagnetic radiation in the visible spectrum and to emit signals of ultraviolet radiation.

It will be appreciated, that by selection of particular upconverting materials which absorb and emit electromagnetic radiation at different wavelengths specific to the upconverting material selected, it is possible to provide a high degree of security as it will be difficult for counterfeiters to reproduce the security documents containing the specific upconverting material selected.

It is also possible for the at least one opacifying coating to be applied so that it only partly covers the substrate. In this case, signals of different strengths emitted from the covered and uncovered parts of the substrate may be analysed to authenticate the security document.

Preferred embodiments of the invention will now be described, by way of example only, with reference to the accompanying drawings, in which:

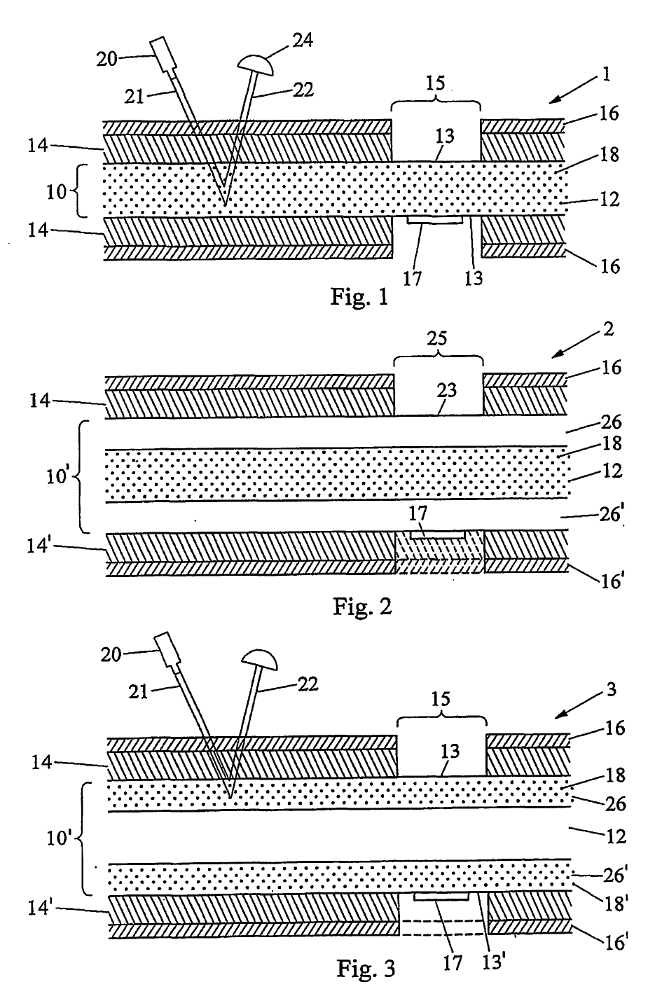

FIG. 1 is a sectional view through part of a security document in accordance with a first embodiment of the invention;

FIG. 2 is a sectional view through a security document in accordance with a second embodiment of the invention; and

FIG. 3 is a sectional view through a security document in accordance with a third embodiment of the invention.

The security document 1 shown in FIG. 1 comprises a substrate 10 in the form of a transparent polymeric base layer 12, an opacifying coating 14 applied to each side of the base layer 12, and a layer of printed indicia 16 applied to the opacifying coating 14 on each side of the document 1.

The base layer 12 contains an upconverting fluorescent material 18 dispersed uniformly throughout the transparent polymeric material forming the base layer 12. The upconverting material 18 is preferably of the type which absorbs electromagnetic radiation at a selected wavelength corresponding to a low energy level, eg. infra-red radiation, and emits electromagnetic radiation at a shorter wavelength corresponding to a higher energy level, eg. in the form of visible light. The base layer 12 is preferably formed from a transparent biaxially oriented polymeric material, such as biaxially oriented polypropylene, though other materials may be used.

The opacifying coatings 14 applied to opposite surfaces of the base layer 12 each comprises at least one refractive pigment, such as titanium dioxide, dispersed in a polymer or resin binder. As shown in FIG. 1, the opacifying coatings 14 and the indicia 16 printed on the coatings 14 are applied to the transparent base layer 12 in such a manner as to cover the base layer 12 only partially, leaving an area 13 of the base layer 12 uncovered to form a transparent portion or “window” 15 which allows light to pass through. The window 15 may include a security device 17, such as an optically variable device (OVD), or an embossing, provided on at least one surface of the uncovered area 13 of the base layer 12. The security device 17 is therefore able to be inspected through the window 15 from both sides of the security document.

The upconverting material 18 is present in the base layer 12 in only small quantities so that it does not affect the transparency of the base layer 12. Preferably, the concentration of the upconverting material 18 is not more than about 1% by weight of the polymeric material forming the base layer 12, and more preferably falls within the range from about 0.0025% to 0.25% by weight of the polymeric material.

In use, when it is desired to verify the authenticity of the security document 1 an infra red source 20, such as an infra red laser, emitting infra red radiation of a chosen wavelength can be used to excite the upconverting material 18 in the base layer 12 causing it to emit visible light signals 22 of a particular wavelength which depends upon the particular upconverting material 18 dispersed in the transparent base layer 12. A detector 24, eg. a photo detector, can be used to detect the light signals 22 emitted by the upconverting material 18 in order to verify the authenticity of the security document 1.

It has surprisingly been found that an opacifying coating 14 which contains a highly refractive pigment, eg. TiO₂, CaCO₃, BaSO₄, ZnO, not only disperses the visible light signals 22 emitted by the upconverting material 18, but also enhances or amplifies the emitted signal 22. This has advantageous effects in widening the area over which the signals 22 are detectable and reducing the lower detection limit (generally defined as the signal level detectable at a value equal or greater than 3 times the background noise signal). This also enables the concentration of the expensive upconverting material 18 in the base substrate 12 to be reduced, which is also advantageous in the case of a security document 1 formed from a transparent base substrate 12 and having a transparent portion or window 15.

A further advantage of the embodiment of FIG. 1 is that because the upconverting material 18 is dispersed uniformly throughout the base layer 12, the signals 22 emitted from the upconverting material 18 can be detected at any location on the security document 1. It will, however, be appreciated that signals emitted in the area of the window 15 will not be as strong owing to the absence of the opacifying coating 14 with refractive pigment in that area.

The differences between the respective strengths of the signals emitted from the covered and uncovered areas of the substrate may also be used for authenticating particular security documents.

Referring to FIG. 2, there is shown a modified embodiment of a security document 2 in accordance with the invention. The security document 2 is similar to that of FIG. 1 and corresponding reference numerals have been applied to corresponding parts. Therefore, the security document 2 includes a base layer 12 formed from a transparent polymeric material containing an upconverting fluorescent material 18, opacifying coatings 14,14′ on each side of the base layer 12, and indicia 16,16′ printed on the opacifying coatings 14.

The security document 2 differs from that of FIG. 1 in that the further layers of transparent polymeric material 26, 26′ are provided on each surface of the base layer 12 to form a composite substrate 10′ with the opacifying coatings 14 applied to the outer surfaces of the polymeric layers 26, 26′.

The transparent polymeric layers 26, 26′ may be formed from at least one co-polymer. Examples of suitable polymeric materials include, polypropylene, polyethylene and random co-polymers, such as polybutylene-ter-polymers.

Another difference is shown in broken lines in FIG. 2, in that the opacifying coating 14′ and indicia 16′ on one side of the substrate 10′ (the lower side of FIG. 2) may be applied to cover the entire surface of the polymeric layer 26′. The opacifying coating 14 and indicia 16 on the other side of the substrate 10′ (the upper side in FIG. 2) are applied to the surface of the polymeric layer 26 in such a manner as to leave an area 23 of the surface of the layer 26 uncovered to form a “half window” 25 on that side of the security document 2. The uncovered area 23 or “half window” 25 enables an observer to view the security device 17 from said other side of the security document 2, but the security device 17 is obscured or at least partially obscured by the opacifying coating 14′ and indicia 16′ on said one side of the security document 2. The security device 17 may be provided on the outer surface of either of the polymeric layers 26, 26′ or even on the outer surface of the base layer 12.

As in the embodiment of FIG. 1, the authenticity of the security document 2 may be verified by directing infra red radiation from an infra red source (not shown in FIG. 2) onto the security document 2 and using a detector (also not shown in FIG. 2) to detect light signals emitted from the upconverting material 18 dispersed in the base layer 12 of the substrate 10′.

In the embodiment of FIG. 2, it is possible to detect a stronger signal emitted from the area of the half window 25 on the side of the document 2 on which the opacifying coating 14′ and indicia 16′ is applied, than the signal emitted in the region of the full window 15 in the embodiment of FIG. 1. The differences between the respective strengths of the signals emitted from opposite sides of the substrate in the area of the half window may also be used to authenticate particular security documents.

It will, however, be appreciated that instead of a half window 25, the security document 2 of FIG. 2 may have a full window as in the embodiment of FIG. 1. It is also possible for the opacifying coatings 14, 14′ to be applied to cover the entire surfaces of the polymeric layers 26, 26′ so that no window or half window is provided.

Referring to FIG. 3, there is shown a further embodiment of a security document 3 in accordance with the invention. The document 3 is similar to the embodiment of FIG. 2 and corresponding reference numerals have been applied to corresponding parts. Therefore, the security document 3 has a base layer 12 and layers 26, 26′ of transparent polymeric material provided on each side of the base layer 12 to form a composite substrate 10′. Opacifying coatings 14, 14′ are applied to the outer surfaces of the polymeric layers 26, 26′ and indicia 16, 16′ is provided on the opacifying layers 14, 14′, eg. by printing.

The security document 3 differs from the embodiment of FIG. 2 in that the upconverting fluorescent material 18, 18′ is dispersed in the polymeric layers 26, 26′ rather than in the base layer 12. It has been found that if the opacifying layers 14, 14′ are in intimate contact with the polymeric layers in which the upconverting material 18, 18′ is dispersed, a stronger signal 22 emerges from the security document 3 when the document 3 is exposed to a beam of infra red radiation 21 from an infra red source 20, than the signal emerging from the embodiment of FIG. 2.

The security document 3 may include a full window 15 with the opacifying coatings 14, 14′ and indicia 16, 16′ being omitted in areas 13, 13′ of the outer surfaces of the polymeric layers 26, 26′ leaving the security device 17 in the window 15 visible from both sides of the document 3. Alternatively, the security document 3 may have a half window with only one of the opacifying coatings 14, 14′ being omitted in the area of the security device 17. It is also possible for the opacifying coatings 14, 14′ to be applied to cover the entire surfaces of the polymeric layers 26, 26′ so that no window or half window is present in the security document 3. In these latter cases, it is possible for the base layer 12 of the substrate to be formed from an opaque or translucent material, such as a paper or fibrous material, with the upconverting material 18 provided in the polymeric layers 26, 26′, as a transparent base layer 12 is not necessarily required when there is no full window in the security document.

It will be appreciated that various modifications and alterations may be made to the preferred embodiments described herein without departing from the scope and spirit of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A security document comprising a substrate including at least: one layer of polymeric material and containing an upconverting fluorescent material, and at least one coating containing a refractive pigment applied to the substrate, wherein when the security document is exposed to electromagnetic radiation of a particular wavelength the upconverting material emits a signal of electromagnetic radiation of a shorter wavelength and the coating containing the refractive pigment enhances the signal emitted by the upconverting material.

2. A security document as claimed in claim 1 wherein the substrate includes a polymeric base layer.

3. A security document as claimed in claim 2 wherein the base layer is formed from a transparent polymeric material.

4. A security document as claimed in claim 1 wherein the substrate includes a base layer of paper or fibrous material.

5. A security document as claimed in claim 2 wherein the substrate includes one or more layers of polymeric material provided on a base layer.

6. A security document as claimed in claim 2 wherein the upconverting material is dispersed in the base layer.

7. A security document as claimed in claim 5 wherein the upconverting material is dispersed in the at least one layer of polymeric material provided on the base layer.

8. A security document as claimed in claim 1 wherein the coating containing the refractive pigment is in intimate contact with the at least one polymeric layer containing the upconverting material.

9. A security document as claimed in claim 1 wherein the coating containing the refractive pigment is a highly refractive opacifying coating.

10. A security document as claimed in claim 9 wherein the opacifying coating comprises at least one refractive pigment dispersed in a polymeric or resin binder.

11. A security document as claimed in claim 10 wherein the at least one refractive pigment is selected from the group including titanium dioxide, calcium carbonate, barium sulphate and zinc oxide.

12. A security document as claimed in claim 11 wherein the binder is a cross-linked polymeric material.

13. A security document as claimed in claim 11 wherein the binder is selected from the group including acrylics, polyester and polyurethane.

14. A security document as claimed in claim 11 wherein the refractive pigment and the binder are substantially transparent to the excitation wavelengths used to excite the upconverting material.

15. A security document as claimed in claim 14 wherein the refractive index of the pigment is larger than the refractive index of the substrate.

16. A security document as claimed in claim 14 wherein the refractive index of the pigment is larger than the refractive index of the binder.

17. A security document as claimed in claim 15 wherein the refractive index of the pigment is at least 0.3 greater than the refractive index of either the substrate or the binder.

18. A security document as claimed in claim 1 wherein the substrate containing the upconverting fluorescent material is a transparent substrate and the coating containing the refractive pigment is an opacifying coating which is applied only partly over the transparent substrate to form a window on at least one side of the security document which is not covered by the opacifying coating.

19. A security document as claimed in claim 18 wherein the opacifying coating is applied only partly on one side of the substrate, and the opacifying coating is applied to cover the entire surface of the polymeric layer on the opposite side of the substrate.

20. A security document as claimed in claim 18 wherein the signal emitted from parts of the substrate covered by the opacifying coating is stronger than the signal emitted from parts of the substrate which are uncovered by the opacifying coating.

21. A security document as claimed in claim 1 wherein the upconverting material is uniformly dispersed in the polymeric material.

22. A security document as claimed in claim 1 wherein the concentration of upconverting material is not more than about 1% by weight of the polymeric material.

23. A security document as claimed in claim 22 wherein the concentration of upconverting material is substantially within the range from about 0.0025% to about 0.25% by weight of the polymeric material.

24. A method of manufacturing a security document including providing a substrate having at least one layer of polymeric material; incorporating at least one upconverting fluorescent material in the at least one layer of polymeric material; and applying a refractive coating to at least one surface of the substrate, wherein the refractive coating contains at least one refractive pigment which enhances signals emitted from the fluorescent upconverting material when the security document is exposed to electromagnetic radiation of a particular wavelength.

25. A method as claimed in claim 24 wherein the upconverting material is incorporated into the at least one layer of polymeric material in an extrusion process.

26. A method as claimed in claim 25 wherein in the extrusion process, the upconverting material is mixed uniformly with the co-extruded polymeric material as it passes through the extruder and dies.

27. A method as claimed in claim 26 wherein the upconverting material is mixed with the polymeric material, in an extruder barrel, at an elevated temperature.

28. A method as claimed in claim 24 wherein the concentration of the upconverting material is not more than about 1% by weight of the polymeric material.

29. A method as claimed in claim 28 wherein the concentration of upconverting material falls substantially within the range from about 0.0025% to about 0.25% by weight of the polymeric material.

30. A method as claimed in claim 24 wherein the at least one refractive pigment is dispersed in a polymeric or resin binder

31. A method as claimed in claim 24 wherein the at least one refractive pigment is selected from the group including titanium dioxide, calcium carbonate, barium sulphate and zinc oxide.

32. A method of verifying the authenticity of a security document including:
providing a substrate including at least one polymeric layer containing an upconverting fluorescent material;
providing the substrate with at least one opacifying coating containing a refractive pigment;
exposing the upconverting material to electromagnetic radiation of a selected wavelength to excite the upconverting material; and
detecting a signal of electromagnetic radiation emitted from the excited upconverting material at a shorter wavelength than the wavelength selected to excite the upconverting material.

33. A method as claimed in claim 32 wherein the electromagnetic radiation selected to excite the upconverting material is infra red radiation, and the signal of electromagnetic radiation emitted from the upconverting material falls within the visible spectrum.

34. A method as claimed in claim 32 wherein the at least one opacifying coating only partly covers the substrate, and different signals emitted from the covered and uncovered parts of the substrate are analysed to authenticate the security document.

35. A method of manufacturing a security document including: providing a substrate having at least one layer of polymeric material; incorporating at least one upconverting fluorescent material in the at least one layer of polymeric material by an extrusion process; and applying a refractive coating to at least one surface of the substrate.

36. A method as claimed in claim 35 wherein in the extrusion process, the upconverting material is mixed uniformly with the co-extruded polymeric material as it passes through the extruder and dies.

37. A method as claimed in claim 36 wherein the upconverting material is mixed with a polymeric material, in an extruder barrel, at an elevated temperature.

38. A method as claimed in claim 35 wherein the concentration of the upconverting material is not more than about 1% by weight of the polymeric material.

39. A method as claimed in claim 38 wherein the concentration of upconverting material falls substantially within the range from about 0.0025% to about 0.25% by weight of the polymeric material.
